(19) United States
(12) Patent Application Publication
(10) Pub. No.: US 2014/0379603 A1
(43) Pub. Date: Dec. 25, 2014

(54) METHODS AND SYSTEMS FOR ITEM SHIPMENT BASED ON INCOMPLETE INFORMATION

(71) Applicant: ShipHawk, Santa Barbara, CA (US)

(72) Inventors: Jeremy Bodenhamer, Montecito, CA (US); Aaron Freeman, Santa Barbara, CA (US)

(21) Appl. No.: 14/480,459

(22) Filed: Sep. 8, 2014

Related U.S. Application Data
(63) Continuation-in-part of application No. 13/799,858, filed on Mar. 13, 2013.

(51) Int. Cl. G06Q 10/08

(52) U.S. Cl. CPC G06Q 10/083
USPC 705/330

(57) ABSTRACT

Methods and systems for coordinating shipping services for items. Generally, the methods and systems assist a user in determining the cost of shipping items where the user does not have all of the information typically required by a carrier. The method includes receiving an inquiry for a shipping cost with a generic description of the one or more items, where the generic description omits a value for at least one physical characteristic of an item. The method includes identifying, responsive to receiving the generic description, an estimate for the omitted value using a knowledge base, and generating a shipping cost. In some implementations, a server receives, from a second party, an improved description of the item including a more accurate value for the omitted characteristic of the item, and the server then updates the knowledge base, storing the second value for the characteristic of the item.

### CROSS-REFERENCE TO RELATED APPLICATIONS

This application is a continuation-in-part of, and claims the benefit of, U.S. application Ser. No. 13/799,858, filed Mar. 13, 2013, with the title “Methods and Systems for Shipment Coordination of Insufficiently Described Items,” the entirety of which is incorporated by reference.

### BACKGROUND

The present disclosure relates generally to the field of shipping items. Generally, the shipping industry is designed for experts with full knowledge of a package, the package contents, and how to ship the package to a recipient. For example, the expert is generally expected to know the weight and dimensions of a package. The expert may also be expected to know the National Motor Freight Traffic Association (“NMFTA”) freight classification (“NMFC”). A party may wish to ship an item for which some or all of this information is not readily available. For example, a person may wish to ship a lamp, but does not know how much the lamp weighs, how large a box will be needed, how much weight packing material will add, or the freight classification for a lamp.

### SUMMARY

The present disclosure is directed to methods and systems for coordinating shipping services for items. Generally, the methods and systems assist a user in determining the cost of shipping items where the user does not have all of the information generally necessary. In some implementations, the methods and systems enable the user to obtain a price quote for shipping services, purchase the shipping services, and control the purchased shipping service. In some implementations, the shipping services include packaging one or more items to be shipped. In some implementations, the shipping services include a carrier picking up the one or more items to be shipped.

In one aspect, one implementation relates to a method of providing a shipping cost estimate. The method includes receiving an inquiry for an estimated cost to ship one or more items. The method includes receiving a generic description of the one or more items. The generic description omits a value for at least one characteristic required for generating a shipping cost estimate. The method includes identifying, responsive to receiving the generic description, an estimate for the omitted value for the at least one characteristic. The method includes generating a shipping cost estimate using the generic description and the identified estimated value for the at least one characteristic. The method includes providing, to a first party, the shipping cost estimate. The method may be performed by a data processing system.

In some implementations of the method, the method further includes providing, by the data processing system, responsive to receiving the generic description, a collection of two or more narrowing descriptions, receiving a selection of one of the narrowing descriptions, and identifying, by the data processing system, responsive to receiving the selected narrowing description, the estimated value for the at least one omitted characteristic. In some implementations of the method, at least one narrowing description includes an image of one or more items described by the at least one narrowing description. In some implementations of the method, the narrowing descriptions are provided in an ordering based on one of a frequency a narrowing description is selected, a frequency items described by a narrowing description are shipped, or a probability that a narrowing description will be selected, the probability premised on contextual information for the inquiry. In some implementations of the method, the method includes receiving, from a user device, an image of the item, and determining, by the data processing system, from the received image, one or more description terms for the item.

In some implementations of the method, the at least one characteristic is one of an item weight, a package weight, an item dimension, or a package dimension. An item dimension or package dimension may be one of a width, a depth, a height, or a circumference for the item or the package. In some implementations of the method, the at least one characteristic is a freight classification code.

In some implementations of the method, identifying the estimated value for the at least one omitted characteristic includes identifying a typical characteristic value for items known to satisfy the generic description. In some implementations, the typical characteristic value is identified using one of an average, a mean, a median, and a weighted average. For example, a typical characteristic value may be a function of actual values from previous items shipped that match the same description. In some implementations of the method, receiving the inquiry includes receiving, by the data processing system, from the first party, a source location for the one or more items and a destination for the one or more items. In some implementations, the first party is one of a sender, a recipient, or a third-party coordinator.

In some implementations of the method, a server provide an interface to a first party, the interface providing the first party with a plurality of options for describing an item. The server then receives, via the interface, selections of one or more options in the plurality of option, the selections forming a first description of the item, first description omitting a characteristic of the item. The server generates a second description of the item based on a comparison of the first description to a knowledge base of item descriptions stored by the server. The server then provides an estimated cost for shipment of the item based on the second description. The user agrees to ship the object and a second party, different from the first party, takes possession of the item, e.g., to ship the item or to facilitate shipment of the item. The server then obtains, from the second party, a third description of the item including a second value, more accurate, value for the characteristic of the item, and the server then updates the knowledge base, storing the second value for the characteristic of the item.

In one aspect, one implementation relates to a system for providing a shipping cost estimate. The system includes one or more computer processors configured to receive an inquiry for an estimated cost to ship one or more items and to receive a generic description of the one or more items. The generic description omits a value for at least one characteristic required for generating a shipping cost estimate. The one or more processors are further configured to identify, responsive to receiving the generic description, an estimate for the omitted value for the at least one characteristic, generate a shipping cost estimate using the generic description and the identified estimated value for the at least one characteristic, and provide, to a first party, the shipping cost estimate.

In some implementations of the system, the one or more processors are further configured to provide, responsive to receiving the generic description, a collection of two or more narrowing descriptions, receive a selection of one of the narrowing descriptions, and identify, responsive to receiving the selected narrowing description, the estimated value for the at least one omitted characteristic. In some implementations of the system, at least one narrowing description includes an image of one or more items described by the at least one narrowing description. In some implementations of the system, the narrowing descriptions are provided in an ordering based on one of a frequency a narrowing description is selected, a frequency items described by a narrowing description are shipped, or a probability that a narrowing description will be selected, the probability premised on contextual information for the inquiry. In some implementations of the system, the one or more processors are configured to receive, from a user device, an image of the item, and to determine, from the received image, one or more description terms for the item.

In some implementations of the system, the at least one characteristic is one of an item weight, a package weight, an item dimension, or a package dimension. An item dimension or package dimension may be one of a width, a depth, a height, or a circumference for the item or the package. In some implementations of the system, the at least one characteristic is a freight classification code.

In some implementations of the system, the one or more processors are configured to identify the estimated value for the at least one omitted characteristic by identifying a typical characteristic value for items known to satisfy the generic description. In some implementations, the typical characteristic value is identified using one of an average, a mean, a median, and a weighted average. For example, a typical characteristic value may be a function of actual values from previous items shipped that match the same description. In some implementations of the system, receiving the inquiry includes receiving, by the data processing system, from the first party, a source location for the one or more items and a destination for the one or more items. In some implementations, the first party is one of a sender, a recipient, or a third-party coordinator.

These and other aspects, embodiments, and implementations are discussed in detail below. The foregoing information and the following detailed description include illustrative examples of various aspects, embodiments, and implementations, and provide an overview or framework for understanding the nature and character of the claims. The drawings provide illustration and a further understanding thereof, and are incorporated into and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIGS. 1A and 1B are block diagrams illustrating network environments comprising user devices in communication with servers via a network;

FIG. 2 is a block diagram illustrating a general architecture of a computer useful in connection with the methods and systems described herein;

FIGS. 3A and 3B are block diagrams illustrating shipping a package;

FIG. 3C is a block diagram illustrating using a mobile device to ship a package;

FIG. 4 is a block diagram of an example interface;

FIG. 5 is a flowchart illustrating a method for narrowing a generic description of an item;

FIG. 6 is a flowchart illustrating a method for providing a shipping cost estimate;

FIG. 7 is a flowchart illustrating a method for improving a knowledge base of item descriptions; and

FIG. 8 is a flowchart illustrating a method for calculating an estimated value for a characteristic of an item.

### DETAILED DESCRIPTION

Following below are more detailed descriptions of various concepts related to, and implementations of, methods, apparatuses, and systems introduced above. The various concepts introduced above and discussed in greater detail below may be implemented in any of numerous ways, as the concepts described are not limited to any particular manner of embodiment or implementation. Specific examples are provided primarily for illustrative purposes.

Generally, a user employs the services of a carrier to ship one or more items from a first location to a second location. Examples of carriers include the United States Postal Service (“USPS”), FedEx Corporation (“FedEx”), United Parcel Services, Inc. (“UPS”), YRC Worldwide Inc. (“YRC”), Purolator Inc. (“Purolator”), Deutsche Post AG (“DHL”), and their various partners and subsidiaries. Carriers may include individual owned and operated trucking or freight service providers, couriers, movers, and any other entity engaged in transportation of freight. In some instances, a carrier may pick-up and/or package items for shipping. Multiple carriers may participate in a shipment. For example, a local packing company may receive an item and package it, a regional company may transport the package from the local company to a regional hub, a long distance carrier may transport the package from the regional hub to a second regional hub, and a local delivery service provider may transport the package from the second hub to a delivery destination. These shipment participants would all be considered carriers.

Generally, an anticipated user may not be fully prepared or informed about shipping items. The items may be packed by the user, or the user may request additional packing services. The user may need assistance packaging items and anticipating costs. The users might not be an expert shipper or might not ship items with great frequency. The user may be in possession of the items, may be the intended recipient for the items, or may be a third-party coordinator (e.g., a gift buyer). The user may be both the sender and the receiver, e.g., someone moving. The user may not have considered restrictions or special handling requirements for shipping certain materials. For example, a user may wish to ship a lawn mower and has not considered that the fuel tank may be considered hazardous. The methods and systems described anticipate these and other shipping complications, easing the user's shipping experience regardless of carrier employed.

Generally, a carrier will require certain information about a package in order to determine the cost to ship the package. The information may include an initial pick-up location and a delivery destination. The information may include detailed characteristics about the package. Package characteristics may include a weight and/or dimensions for the package. Carriers generally require the dimensions to be structured as some combination or function of the package's maximal height, width, depth (or length), base area, circumference, or overall volume. For example, a carrier may require the maximum height, the base width, and base depth (or maximum width or depth). As another example, a carrier may require the maximum height and the maximum circumference, with no regard to the width or depth. Some carriers require that the package fit within a predefined space. Carriers may require an indication if a package is fragile (e.g., books may require less care than glass art) or if a package contains hazardous materials. Carriers may require additional information or insurance where special handling is required. Some carriers may require a classification code for the package contents, e.g., the National Motor Freight Traffic Association (“NMFTA”) freight classification (“NMFC”).

In general, a user sending an item (or multiple items) doesn't know all of this information prior to packing the item(s) for shipping. The user might not know if the carrier will pick up the package or if it has to be dropped at a shipping office. The user might not know exactly where the package is going, e.g., a person selling an item via an on-line auction may wish to specify the likely shipping charge without knowing who the buyer will be or where they reside. The user might not know how best to pack the items to be shipped, or what the resulting package will weigh, how large the box or crate will be, or how the package might be classified. The user may only know that they wish to ship an item and want a quote of how much shipping will likely cost. The user may be shipping a small object such as a book or curio, a mid-sized object such as a lamp or stereo, or a larger object such as a table, statue, or surfboard. However, many of these objects are relatively common and a reasonable estimate of their respective packaging characteristics can be determined even from a broad description.

For example, a surfboard generally weighs between 5 pounds and 25 pounds, is between 6 to 10 feet long, between 19 and 24 inches wide, and 2 to 4 inches thick (not accounting for “rocker” curvature or fins). Even with no additional information, the generic description “surfboard” may be sufficient to estimate the size and weight of a packed shipping crate and to thus determine a shipping cost estimate. If the user can provide even a little more detail, the weight and dimension ranges can be narrowed. For example, using just a few of the many types of surfboards, if the user knows if the surfboard is a “short board,” a “fun board,” or a “long board,” then the ranges can be narrowed according. For example, a “short board” generally weighs 4.6 to 9 pounds, a “fun board” generally weighs 6.2 to 12 pounds, and a “long board” may weigh as much as 25 pounds or more. These weight ranges can be further narrowed if the user knows the material used to make the board, e.g., polyurethane, balsa, or wood. Additionally, a “short board” is generally 6 to 7 feet long, a “fun board” is generally 6.5 to 8 feet long, and a “long board” is generally 8 to 10 feet long. Long boards are less common, so most boards are roughly 6 to 8 feet long. While some boards may be slightly outside the likely range, a reasonable estimate of the shipping costs can be made based on the typical weight range and packing requirements for the generic description provided by the user. Thus the user does not need to actually weigh or measure the board. In some of the implementations described herein, data such as typical weights and dimensions for items that might be shipped is stored and used to predict characteristics of similar items. These predictions can be used to estimate shipping costs.

In an example usage of the systems and methods described, a user wishes to purchase an item displayed in a “for sale” ad posted to an online classifieds page. The item may be a surfboard, an antique lamp, or anything else that can be transported. The person selling the item may state in the ad that the buyer must collect the item, but the buyer is unable to do so. For example, the buyer may be geographically distant. Instead, the buyer offers to send the seller everything needed to package the lamp and to arrange for a carrier to pick up the package at an agreed upon date and time. The seller may agree to this. The seller may refuse to package the item, but will allow someone to pick up the item and handle the packing. The buyer accesses a website and enters a limited description of the item. The buyer does not know the exact dimensions or weight of the item, however, the website is able to automatically and immediately provide a quote without requiring the user (in this example, the buyer) to interact with a person or to wait for a response from a person. The website may also enable the buyer to purchase insurance and other services. The website warns the user of potential complications, e.g., if the item is hazardous, requires special handling, or is underinsured. The website may enable the buyer to send packing materials (e.g., a box and proper padding) and a diagram of packing instructions to the seller. The website may enable the buyer to purchase shipping services from a carrier who will pick up and, if necessary, pack the item. The website may provide a link or order number that can enable the carrier to view a materials list for packing the item. The website may provide a link or order number for the seller. For example, if the seller needs to change the pick-up date, the seller can access the website and alter the pick-up arrangement. The carrier picks up the item and transports it to the buyer. The website may enable the buyer to track the status of the package from the moment the buyer places the order. The buyer may receive an e-mail or text message when the item has been picked up and/or when the item has been delivered.

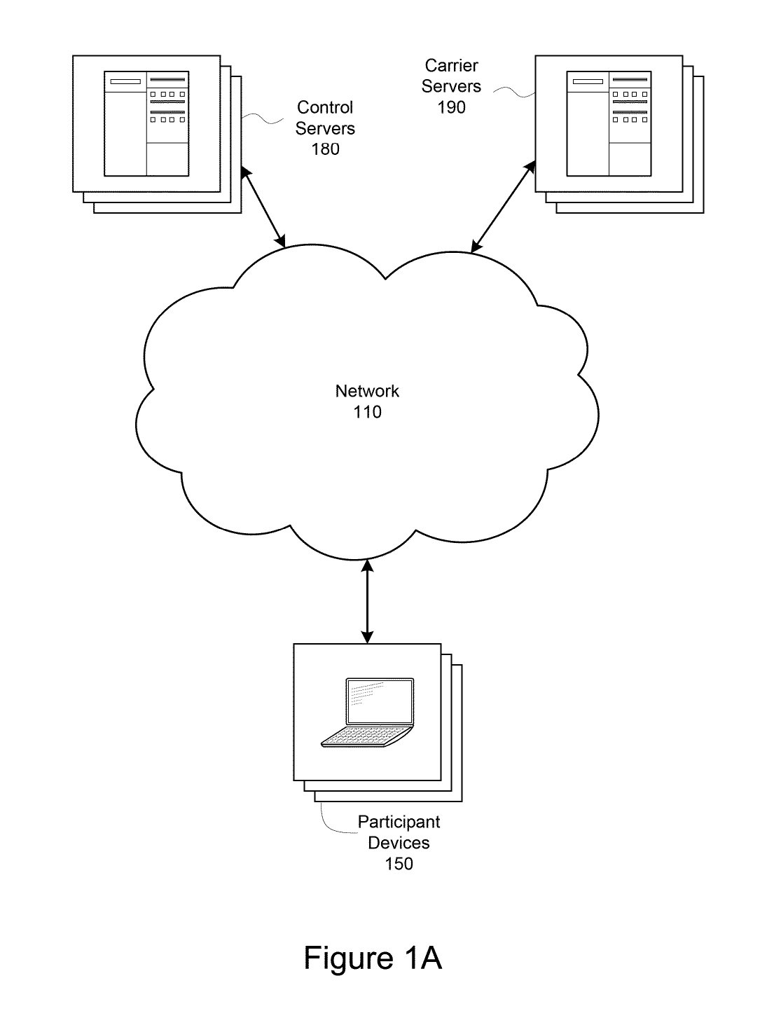

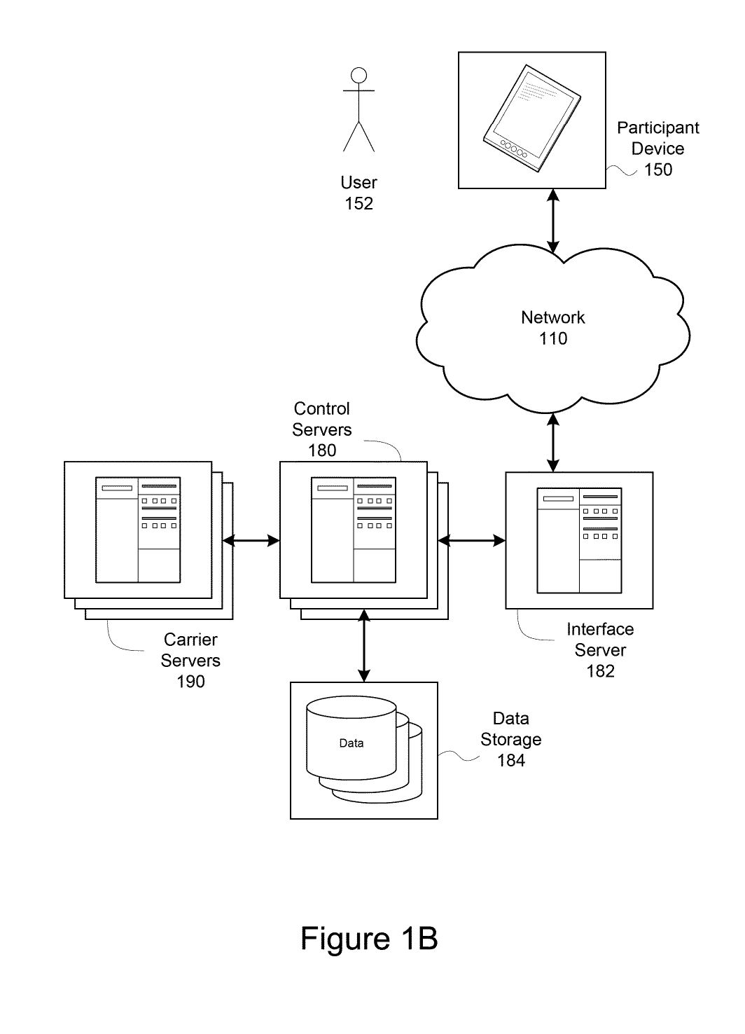

FIG. 1A illustrates a generalized networked computing environment wherein computer systems interact and communicate via a network 110. Persons wishing to ship items may use the system to coordinate shipping services provided by one or more carriers. In particular, a user interacts with the system using a participant device 150. The participant device 150 communicates, via the network 110, with one or more control servers 180. The control servers 180 coordinate the desired shipping and communicate with carrier servers 190 for the carriers employed in the shipping process. Generally, a user may use one or more participant devices 150. In some implementations, the carrier servers 190 communicate, via the network 110, with a participant device 150.

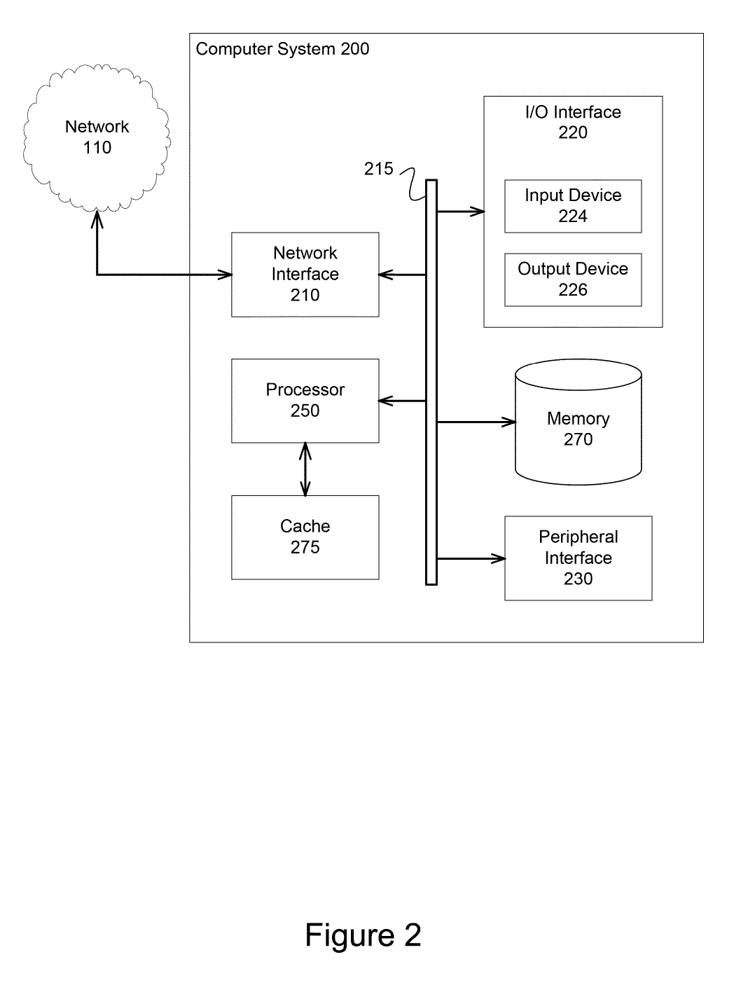

A participant device 150 may be any computing device capable of communication via the network 110. The participant device 150 may be a smart phone, a tablet, a laptop, a gaming device, a television set-top box, a personal computer, a desktop computer, a server, or any other computing device. A user wishing to ship one or more items uses the participant device 150 to interact with the system. Generally, the participant device 150 provides or presents an interface for this interaction. The participant device 150 may provide an input interface, e.g., a keyboard, a mouse, or a touch screen. The participant device 150 may provide an output interface, e.g., a screen, a speaker, or a printer. In some implementations, the user is presented with an interface in the form of a web page. In some implementations, the participant device 150 is a computer system 200, as illustrated in FIG. 2 and described below.

In general, the carrier servers 190 are servers operated by or on behalf of one or more carriers. Carrier servers 190 generally facilitate logistics. For example, a carrier server may facilitate the purchase of shipping services by a user or provide tracking services once a package has been shipped. Carrier servers 190 may provide an interface for third-parties to interact with the carrier, e.g., via one or more web sites, an application programming interface (“API”), or a bespoke interface. In some implementations, a carrier server 190 is a virtual server or service operated in a cloud computing environment. In some implementations, a carrier server 190 is a computer system 200, as illustrated in FIG. 2 and described below.

In general, the control servers 180 are servers operated to coordinate shipping services for a user of a participant device 150. The control servers 180 may generate one or more interfaces by which a participant can obtain shipping quotes and purchase shipping services. The control servers 180 may interact with one or more carrier servers 190 to coordinate shipping requests on behalf of a user. The carrier servers 190 may be operated by different entities than the operator of the control server 180, i.e., the carriers may be third-parties. In some implementations, a control server 180 is a virtual server or service operated in a cloud computing environment. In some implementations, a control server 180 is a computer system 200, as illustrated in FIG. 2 and described below.

The network 110 can be a local-area network (LAN), such as a company intranet, a metropolitan area network (MAN), or a wide area network (WAN), such as the Internet and the World Wide Web. The network 110 may be any type and/or form of network and may include any of a point-to-point network, a broadcast network, a wide area network, a local area network, a telecommunications network, a data communication network, a computer network, an asynchronous transfer mode (ATM) network, a synchronous optical network (SONET), a wireless network, an optical fiber network, and a wired network. In some implementations, there are multiple networks 110 between participants, for example a smart phone 170c typically communicates with Internet servers via a wireless network connected to a private corporate network connected to the Internet. The network 110 may be public, private, or a combination of public and private networks. The topology of the network 110 may be a bus, star, ring, or any other network topology capable of the operations described herein. The network 110 can be used to access the auction server 150 by at least one user device 170, such as a laptop, desktop, tablet, electronic pad, personal digital assistant, smart phone, video game device, television, kiosk, or portable computer.

FIG. 1B illustrates a user interaction with an interface for a shipping system. The user 152 interacts with a participant device 150 communicatively connected to a network 110. The participant device 150 enables the user to interact with the control servers 180 illustrated in FIG. 1a. For example, as illustrated in FIG. 1b, the participant device 150 presents the user 152 with an interface in communication with an interface server 182 via the network 110. The interface server 182 facilitates communication by the user 152 with the control servers 180. The control servers 180 retrieve data from data storage 184, e.g., a database, and use the data to assist the user 152. For example, the control servers 180 may enable the user 152 to purchase shipping services from a carrier server 190 using data stored in, or derived from, the data storage 184.

The user 152 may be any person involved in shipping an item to a recipient. For example, the user 152 may be a person with one or more items to send (a sender). The user 152 may be a person looking for a shipping quote, with no immediate shipping needs, e.g., a seller wishing to include a shipping estimate in a price. The user 152 may be a person wishing to receive items, e.g., a buyer at an auction. The user 152 may be a third-party, e.g., a person wishing to buy an item from a seller and have the item shipped to a recipient. In some implementations, multiple users may participate in a single shipping event. For example, a first user may initiate the shipping purchase and a second user may alter the arrangement.

Generally, the user 152 interacts with a participant device 150 communicatively connected to a network 110. For example, the participant device 150 may present the user 152 with a web site provided or hosted by an interface server 182 acting as a web server. The web site may provide the user 152 with information and options. For example, the web site may guide the user from a basic description of an object to be shipped (e.g., a surfboard) to a narrower generic description (e.g., “short board”). In some implementations, the user 152 uses the interface to input or select a generic description of an item to be shipped and the interface server 182 responds with a collection of narrower descriptions from which the user 152 may select to better describe the item to be shipped.

The interface server 182 facilitates communication by the user 152 with the control servers 180. In some implementations, the interface server 182 is a web server. In some implementations, the interface server 182 communicates with a customized application running on the participant device 150. For example, the participant device 150 may be a tablet running specialized “apps” and the user 152 may choose to run an app for a shipping service where the selected app communicates with the interface server 182, via the network 110, to coordinate shipping services for the user 152.

The control servers 180 retrieve data from data storage 184 and use the data to assist the user 152. For example, the control servers 180 may enable the user 152 to purchase shipping services from a carrier server 190 using data stored in, or derived from, the data storage 184. In some implementations, the data storage 184 is a database. In some implementations, the data storage is a network attached storage system. In some implementations, the data storage is a storage area network. In some implementations, the data storage 184 is geographically distributed. In some implementations, the data storage 184 stores data entries for each item shipped.

In some implementations, the data storage 184 store characteristic data about items that may be shipped, such as surfboards. This data is used to predict characteristics of similar items. The data may be used to estimate shipping costs for items with similar descriptions. In some implementations, the data is determined from catalogs. In some implementations, the data is determined from past shipments. In some implementations, the data is determined from Internet data sources. In some implementations, the data is determined by exploring e-commerce web sites, e.g., using spider or page-scraping software.

In some implementations, an interface server 182 is a virtual server or service operated in a cloud computing environment. In some implementations, an interface server 182 is a computer system 200, as illustrated in FIG. 2 and described below. In some implementations, an interface server 182 is incorporated into, or otherwise a part of, a control server 180. In some implementations, a data storage system 184 is a virtual server or service operated in a cloud computing environment. In some implementations, a data storage system 184 is a computer system 200, as illustrated in FIG. 2 and described below. In some implementations, a data storage system 184 is incorporated into, or otherwise a part of, a control server 180. In some implementations, the control servers 180 communicate with one or more of an interface server 182, a data storage system 184, or a carrier servers 190, via a network 110. In some implementations, the control servers 180 communicate with one or more of an interface server 182, a data storage system 184, or a carrier servers 190, via a private network or a virtual private network operating in a public network, e.g., the Internet.

FIG. 2 illustrates an example computer system 200 suitable for use in implementing the computerized components described herein. The example computer system 200 includes one or more processors 250 in communication, via a bus 215, with one or more network interfaces 210 (in communication with the network 110), I/O interfaces 220 (for interacting with a user or administrator), and memory 270. The processor 250 incorporates, or is directly connected to, additional cache memory 275. In some uses, additional components are in communication with the computer system 200 via a peripheral interface 230. In some uses, such as in a server context, there is no I/O interface 220 or the I/O interface 220 is not used. In some uses, the I/O interface 220 supports an input device 224 and/or an output device 226. In some uses, the input device 224 and the output device 226 use the same hardware, for example, as in a touch screen.

In some implementations, the participant devices 150, control servers 180, and carrier servers 190, illustrated in FIG. 1, are constructed to be similar to the computer system 200 of FIG. 2. For example, a user interacts with an input device 224, e.g., a keyboard, mouse, or touch screen, to access an interface, e.g., a web page, over the network 110. The interaction is received at the user's device's interface 210, and responses are output via output device 226, e.g., a display, screen, touch screen, or speakers.

In some implementations, one or more of the servers illustrated in FIG. 1 are constructed to be similar to the computer system 200 of FIG. 2. In some implementations, a server may be made up of multiple computer systems 200. In some implementations, a server may be a virtual server, for example, a cloud-based server. A server as illustrated in FIG. 1 may be made up of multiple computer systems 200 sharing a location or distributed across multiple locations. The multiple computer systems 200 forming a server may communicate using the user-accessible network 110. The multiple computer systems 200 forming a server may communicate using a private network, e.g., a network distinct from the user-accessible network 110 or a virtual private network within the user-accessible network 110.

The processor 250 may be any logic circuitry that processes instructions, e.g., instructions fetched from the memory 270 or cache 275. In many implementations, the processor 250 is a microprocessor unit, such as: any of the various processors manufactured by Intel Corporation of Mountain View, Calif.; those manufactured by Motorola Corporation of Schaumburg, Ill.; those manufactured by International Business Machines of White Plains, N.Y.; or those manufactured by Advanced Micro Devices of Sunnyvale, Calif. The computing device 200 may be based on any of these processors, or any other processor capable of operating as described herein. The processor 250 may be a single core or multi-core processor. The processor 250 may be multiple processors.

The I/O interface 220 may support a wide variety of devices. Examples of an input device 224 include a keyboard, mouse, touch or track pad, trackball, microphone, touch screen, or drawing tablet. Example of an output device 226 include a video display, touch screen, speaker, inkjet printer, laser printer, dye-sublimation printer, or 3D printer. In some implementations, an input device 224 and/or output device 226 may function as a peripheral device connected via a peripheral interface 230.

A peripheral interface 230 supports connection of additional peripheral devices to the computing system 200. The peripheral devices may be connected physically, as in a FireWire or universal serial bus (USB) device, or wirelessly, as in a Bluetooth device. Examples of peripherals include keyboards, pointing devices, display devices, audio devices, hubs, printers, media reading devices, storage devices, hardware accelerators, sound processors, graphics processors, antennae, signal receivers, measurement devices, and data conversion devices. In some uses, peripherals include a network interface and connect with the computer system 200 via the network 110 and the network interface 210. For example, a printing device may be a network accessible printer.

The computer system 200 can be any workstation, desktop computer, laptop or notebook computer, server, handheld computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. For example, the computer system 200 may comprise a gaming device such as a PlayStation (PS 1/2/3/4/x) or Personal PlayStation Portable (PSP) device manufactured by the Sony Corporation of Tokyo, Japan, a Nintendo, Game Boy, or Wii device manufactured by Nintendo Co., Ltd., of Kyoto, Japan, or an XBox or XBox 360 device manufactured by the Microsoft Corporation of Redmond, Wash. For example, the computer system 200 may comprise a tablet device such as one of the iPad family of devices manufactured by Apple Computer of Cupertino, Calif.

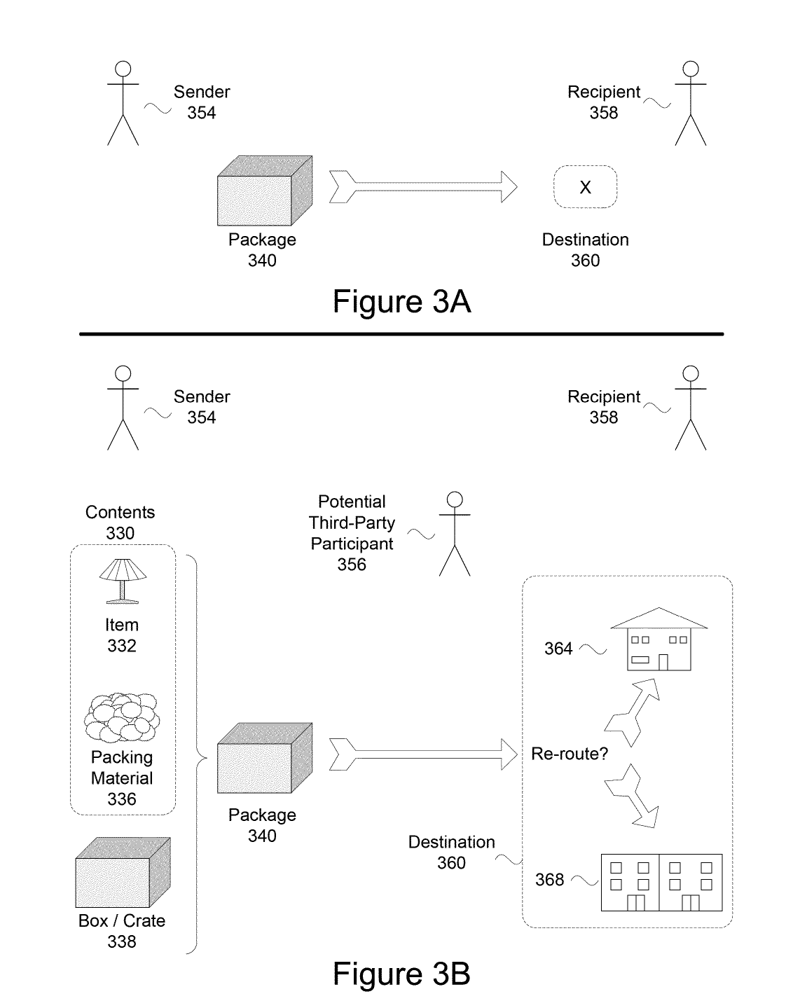

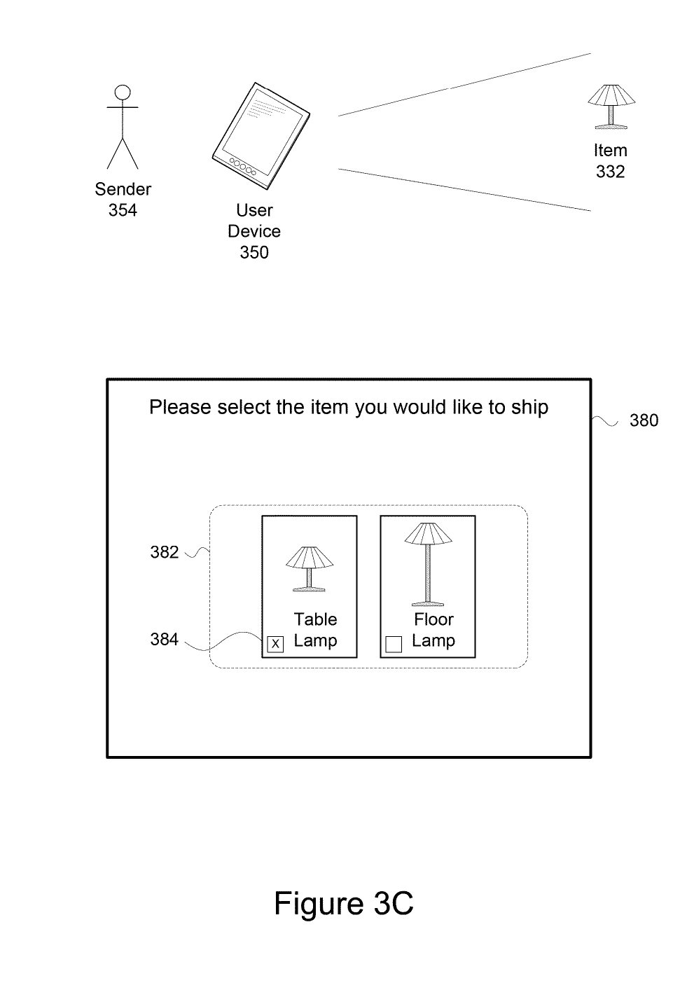

FIG. 3A illustrates a simplified view of shipping. A sender 354 ships a package 340 to a recipient 358 at a destination 360. In the simplified view, the sender 354 is the only active participant and the package 340 is easily characterized in a manner idealized by a carrier. The recipient 358 is typically a passive participant waiting patiently at the destination 360. This simplified view of shipping masks many of the realities of shipping described above.

FIG. 3B illustrates a more complex view of shipping. As in FIG. 3a, a package 340 is shipped to a recipient 358. However, active participants may include the sender 354, the recipient 358, or a potential third-party participant 356, any of whom may take an active role in coordinating shipping services. FIG. 3b further illustrates that a package 340 is really a combination of contents 330, e.g., one or more items 332 plus packing material 336, and a container 338 (e.g., a box or crate, not to be confused with a steel intermodal shipping container of the kind loaded on sea vessels, trains, and trucks). Likewise, the destination 360 may be subject to change. For example, a recipient 358 may prefer to reroute a package originally destined for a residence 364 to be delivered, instead, to a workplace 368.

In some implementations, a user has some knowledge of the item 332 to be shipped, but not the overall package 340. That is, the user may know that he or she wishes to ship a lamp, but does not know the weight or dimensions for a properly packed lamp. The user may require a quote for the shipping costs prior to having packed the item 332. A system for estimating these costs may take into account the proper packing material 336 and box or crate 338. The system may provide a recommendation for how best to pack an item 332 to minimize shipping costs for the resulting package 340. For example, a system may recognize that using a more expensive but thinner packing material may enable the use of a smaller box, e.g., where the smaller box may create a shipping price reduction that offsets the increased cost of the packing material. In some implementations, the system may select a standardized box size or may recommend modifying a standardized box size. In some implementations, the system generates a recommendation for packing an item 332 and provides that recommendation to the user or to a packing service. In some implementations, the system provides instructions for packing the item 332. In some implementations, the system provides the instructions as an audio or multi-media presentation, for example, a computer generated animation of the item 332 being packed. In some implementations, the system provides an illustration or diagram of how to pack items. In some implementations, the system provides a list of materials to be used for packing, e.g., a specific quantity of packing material 336 and a specific size for the box 338. This materials list may be presented with an option to purchase all or some of the items on the materials list and have the purchased packing materials delivered to the shipper.

In some implementations, a user is the sender 354. In some implementations, a user is the recipient 358. In some implementations, the sender 354 is the recipient 358. In some implementations, a user is some third-party participant 356, e.g., a person purchasing a gift from a sender 354 for delivery to a gift recipient 358. A third-party participant 356 may have very limited knowledge of the item 332 to be shipped. However, the third-party participant 356 may still need an accurate quote of the estimated shipping costs.

In some implementations, a user may wish to re-route the shipping of a package. The need to re-route might not be known when quoting estimated shipping costs. However, some reasonable predictions may be made. For example, a recipient 358 may expect delivery at a residence 364. The recipient 358, who might not be the same user that purchased the shipping, might request that delivery be re-routed to a workplace 368. Generally, long distance shipping routes a package to a regional hub. If the hub services both the initial destination and the re-routed destination, then there may be minimal or zero cost impact in rerouting. The control servers 180 can therefore enable a recipient user 358 to reroute packages without burdening shipping costs. Where rerouting creates additional costs, the control servers 180 may bill the recipient user 358 at the time of the reroute request or bill an initial user who first requested shipping services.

FIG. 3C is a block diagram illustrating using a mobile device to ship a package. A sender 354 uses a mobile user device 350 to coordinate shipping services for an item 332. The sender 354 may be the user 152 described in reference to FIG. 1B. The mobile user device 350 is an example of a participant device 150 as described in reference to FIGS. 1A and 1B. Referring still to FIG. 3C, the mobile user device 350 includes an optical imaging element, such as an integrated digital camera. In some implementations, the user device 350 is a mobile electronic device that includes at least a digital camera component, a data communication component, and a user interface component. The user device 350 captures an image using the digital camera component and transmits it to other electronic devices via the data communication component. For example, in some implementations, the data communication component is a radio link for communicating with a network via 3G, 4G, WiFi, Bluetooth®, or any other data radio communication protocol. In some implementations, the user device 350 is a notebook computer, or a laptop computer, a mobile phone, a smart phone, a tablet device such as an Apple® iPad®. The user device 350 may be used, by the sender 354, to capture an image of the item 332 to be shipped. The sender 354 can then be presented with an interface 380 with options for identifying the item 332 in the resulting image. In some implementations, an image processing software executes to recognize items depicted in the image. In some implementations, the sender 354 is asked to help identify the item 332 in the image. For example, the sender 354 may be presented a selection menu 382. The image processing software may determine that the image is of a lamp, but not be able to accurately gauge the scale of the lamp. The sender 354 may then be presented with an option to categorize the image as a picture of a table lamp or a floor lamp. The sender 354 then selects 384 the correct choice. The sender can then request to ship the item 332 without having to provide precise details about the item 332.

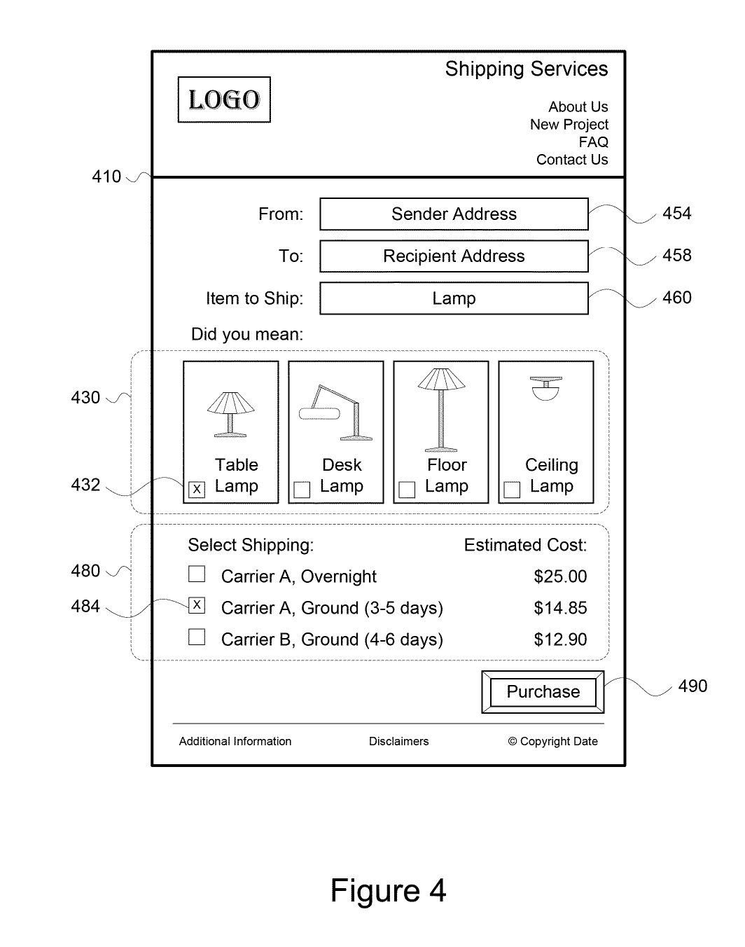

FIG. 4 illustrates an example interface 410 for coordinating shipping services. The interface 410, as illustrated, includes space for a user to enter a sender address 454 and a recipient address 458. The interface also provides space 460 for the user to indicate an item to be shipped. Generally, the user provides or selects a generic description of the item, e.g., “Lamp”, and the interface provides various narrowing descriptions 430, e.g., “Table Lamp,” “Desk Lamp,” “Floor Lamp,” and “Ceiling Lamp.” The user may select 432 one of the narrowing descriptions to better describe the item to be shipped. The interface, as illustrated, provides a menu 480 of carrier options and enables the user to select 484 a desired option. Once satisfied, the user may indicate that he or she wishes to purchase the selected shipping option 484, e.g., using a submit or purchase button 490.

The interface 410 may be generated by a controller server 180 and presented on a participant device 150. For example, the presentation may be as a web page in a web browser. In some implementations, the interface is provided as an application. An interface user may be a sender 354, a recipient 358, or some third-party participant 356. For example, a third-party user 356 may wish to purchase an item from a seller 354 and have the item delivered to a recipient 358, e.g., as a gift. The interface 410 is designed to guide the user through a process to purchase shipping. Further, the interface 410 is designed so that the user does not need to be in possession of items to be shipped nor to have a perfect description of the items. The interface 410 presents an automated process whereby an estimated price is determined and quoted to the user. In some implementations, the price presented is the price charged regardless of the actual costs charged by carriers. In some implementations, the user agrees that the price is an estimate and that the actual price charged may vary.

The interface 410, as illustrated, provides space for a user to enter a sender address 454 and a recipient address 458. In some implementations, the sender address 454 is already known to the system and not entered by the user. For example, the interface may be integrated into an online store front for e-commerce. The integrated interface knows where the package will originate and does not need the user to provide this information. In some implementations, the recipient address 458 is already known to the system and not entered by the user. For example, the user may have an account with a designated recipient address. In some implementations, the interface 410 supports use of an address with varying particularity. For example, the user may a destination delivery area, e.g., a zip code, a city, a county, a state, a shipping zone, a country, or any other method of specifying a delivery area. In some implementations the sender address 454 or recipient address 458 may be a store identifier, e.g., a store number for a chain of packaging stores.

The interface 410 provides space 460 for the user to indicate an item to be shipped. In some implementations, the user selects from a menu, e.g., a drop down menu. In some implementations, the user is presented a collection of images and the user selects from the images. In some implementations, a user provides a free form description, e.g., the user enters a text description or provides an audible description to a speech recognition system. In some implementations, keywords are identified in the free form description and the identified keywords are used to determine an initial generic description. In some implementations, the user provides an image file. In some implementations, the user is provided an option to capture an image of the item to be shipped, e.g., using a digital camera such as a built in camera component of the user device.

Generally, the user provides or selects an initial generic description of the item, e.g., “Lamp”, and the interface provides various narrowing descriptions 430, e.g., “Table Lamp,” “Desk Lamp,” “Floor Lamp,” and “Ceiling Lamp.” In some implementations, the narrowing descriptions include images of a similar item, for example, as illustrated in FIG. 4. The user may select 432 one of the narrowing descriptions to better describe the item to be shipped. When the user selects a narrower description of the item to be shipped, the interface 410 may present additional, even narrower, descriptions. For example, FIG. 4 illustrates selection of a table lamp as a narrower description of a lamp. The interface may then suggest that the lamp is a brass lamp, a ceramic lamp, a composite lamp, a crystal lamp, a glass lamp, etc. Each selection may be iteratively expanded with additional, narrower, descriptions of the item. In this manner, the user selects the best available description of the item using common terminology and imagery. In some implementations, the narrowing descriptions are generated based on data in data storage 184.

In some implementations, the narrowing descriptions are presented in an ordering presenting the user with more likely choices first. In some implementations, the ordering is based on a frequency with which respective descriptions are selected. In some implementations, the ordering is based on a frequency with which items described by the respective descriptions are shipped. For example, the most often selected description may be presented first or descriptions of the most frequently shipped items may be presented first. In some implementations, markov chains for sequences of narrowing descriptions are used to predict selection probabilities for narrowing descriptions. In some implementations, narrowing descriptions are presented based on a probability that a narrowing description will be selected premised on contextual information for the inquiry. Contextual information may include (without limitation) a referring website, a shipper or recipient location, other items to be shipped concurrently, or a time of year. For example, skis shipped between November and February may be more likely to be snow skis, while skis shipped between May and August may be more likely to be water skis.

The interface 410 may also provide a menu 480 of carrier options and enable the user to select 484 a desired option. The menu 480 may include multiple carriers and modes of shipping. For example, the menu may include an option for overnight service from Carrier A or ground service from Carrier A. Likewise, the menu may include an option for ground service from Carrier A or Carrier B. The menu 480 may indicate an estimate time until delivery. The menu 480 may indicate an estimate price, based on the item description selected. In some implementations, the price presented takes into account the item 332 to be shipped, plus the anticipated amount of packing material 336 and dimensions of the box or crate 338.

In some implementations, the interface 410 presents additional services or offers. For example, a carrier's service may include packing the item, or items, to be shipped; the price may include this packing service. In some implementations, the options will include an insurance offer. A user may choose to insure the items through the selected carrier. A user may choose to insure the items through a third-party insurer other than the carrier. In some instances, a carrier may represent that insurance is provided, although the insurance provided by the carrier is inadequate or insufficient for the item(s) to be shipped. The interface 410 may present a warning message to the user highlighting this shortcoming. In some implementations, additional offers (including, but not limited to, packing services and insurance) are presented in additional display windows.

An item may be identified as requiring special handling. For example, the item may include hazardous materials. The item may be considered too delicate or expensive for most carriers. In some implementations, when an item requires special handling, the interface 410 displays an indication to the user of the need for special handling. Special handling does not preclude coordinating shipping, if a carrier is available to handle the item.

In some implementations, the system may determine a risk factor for the requested shipping. For example, the system may determine that there is insufficient insurance coverage. The interface 410 may display a message to the user warning the user of the risk factor. The message may be displayed in a separate display window. The message may be provided audibly.

Once satisfied with the selections and quoted price, the user may indicate that he or she wishes to purchase the selected shipping option 484, e.g., using a submit or purchase button 490. The user may then be directed to a payment processing interface. In some implementations, the user is notified that the price is subject to change and informed as to a process for addressing any price change. In some implementations, the price is not subject to change. In some implementations, the user is provided an order number or tracking number. This number may be used to alter the shipping options, e.g., to reschedule a pick-up or to reroute delivery. In some implementations, the user is provided a second number that may be used by other participants. The second number may have restrictions, e.g., a participant accessing the order using the second number may not be able to change some of the options. In some implementations, the first and/or second number is provided to the user as an image, e.g., as a bar code or a QR-code.

In some implementations, the user enters contact information into the interface. For example, the user may provide a mobile number or an e-mail address. The user may request alerts by SMS text message or e-mail when a package is picked up or delivered. In some implementations, the carrier servers 190 generate the alerts. In some implementations, the control servers 180 generate the alerts. In some implementations, the control servers 180 generate the alerts responsive to notification from the carrier servers 190.

In some implementations, the interface user is a person seeking to purchase shipping services, or to at least obtain a quote for shipping services. In some implementations, the interface user is in possession of the items to be shipped. In some implementations, the interface user is not in possession of the items to be shipped, e.g., the user may be the recipient. In some implementations, a recipient arranges and purchases shipping services using the interface to identify the items to be shipped and to select the desired shipping service. In some implementations, the recipient may arranged, via the interface, for a carrier to pick up and package the items to be shipped. In some implementations, the interface user is person seeking to alter shipping arrangements already purchased and in progress. For example, the user may wish to reroute the package to a new destination.

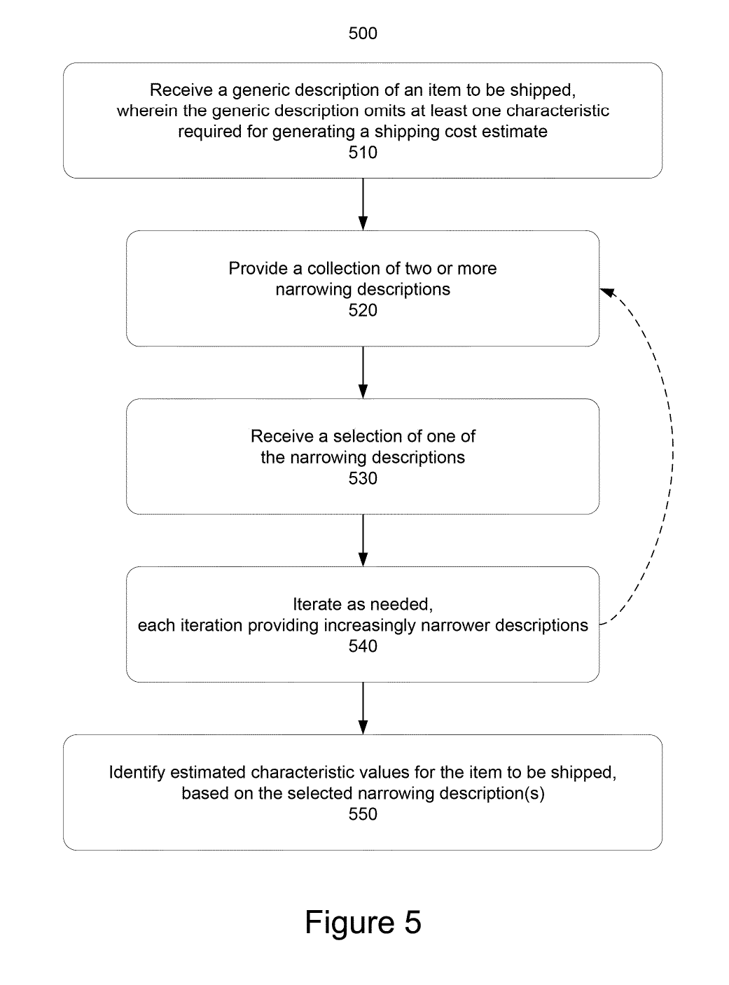

FIG. 5 is a flowchart illustrating a method 500 for narrowing a generic description of an item and determining estimated weight, dimension, and classification values for the item. At step 510, a control server 180 receives a generic description of an item to be shipped. At step 520, the control server 180 provides a collection of two or more narrowing descriptions, e.g., via an interface 410. At step 530, the control server 180 receives a selection of one of the narrowing descriptions. At step 540, the method 500 iterates steps 520 and 530 as needed, each iteration providing increasingly narrower descriptions. At step 550, the control server 180 identifies estimated characteristic values for the item to be shipped, based on the selected narrowing description(s).

At step 510, the control server 180 receives a generic description of an item to be shipped, wherein the generic description omits at least one characteristic required for generating a shipping cost estimate. In some implementations, the control server 180 receives the generic description via an interface 410 presented by a participant device 150. The generic description omits at least one characteristic required. For example, the generic description may fail to include a weight for the item (packed or unpacked); height, base, depth, or width for the item (packed or unpacked), or a classification code (e.g., the National Motor Freight Traffic Association (“NMFTA”) freight classification (“NMFC”) code) for the item. Thus the generic description suggests the item to be shipped but does not identify the item with sufficient particularity to generate a shipping cost estimate.

At step 520, the control server 180 provides a collection of two or more narrowing descriptions, e.g., via an interface 410. For example, as illustrated in FIG. 4, a first generic description of a lamp may result in possible narrowing descriptions including a table lamp, a desk lamp, a floor lamp, and a ceiling lamp. In some implementations, the narrowing descriptions may include text and an image representative of the narrower description. In some implementations, an image is used without a text description. The narrower description may include a weight range typical for the item described. The narrower description may include dimension ranges for the item described. The narrower description may include an appropriate NMFC classification for the item described. In some implementations, each narrowing description is associated with a weight range, dimension ranges, and/or an NMFC classification that is not displayed.

At step 530, the control server 180 receives a selection of one of the narrowing descriptions. For example, a user may interact with an interface 410 to select a narrowing description and the control server 180 receives the selection via the interface 410. In some implementations, the user selects a narrowing description from a drop down menu. In some implementations, the user selects a narrowing description from a decision tree. In some implementations, the user selects a narrowing description from a collection of images.

At step 540, the method 500 iterates as needed, each iteration providing increasingly narrower descriptions. In some implementations, item descriptions are stored in a hierarchy. In some implementations, an item description is stored in association with a collection of possible narrower descriptions. Each iteration drives towards a description associated with a sufficiently narrow weight range and dimension range that a sufficiently accurate shipping cost estimate may be determined by the control server 180. In some implementations, the user is provided an option indicating that the user cannot choose from amongst the narrower description. This may be because the user doesn't have enough information. When the user has selected this option, the control server 180 terminates the iterations. In some implementations, the user eventually selects a narrow description for which the system does not have any narrowing options. When the user has selected such a description, the control server 180 terminates the iterations.

At step 550, the control server 180 identifies estimated characteristic values for the item to be shipped, based on the selected narrowing description(s). Generally, a shipping cost is a function of a package's weight and dimensions. Once the contents of a package are sufficiently understood, a reasonable prediction can be made about the package's weight and dimensions. For example, if an item is known to be a brass table lamp with a paper lamp shade, not more than two feet tall, then a weight range can be determined for similar brass table lamps, a weight can be predicted for packing material needed to protect the lamp, and dimensions for a suitable box can be estimated.

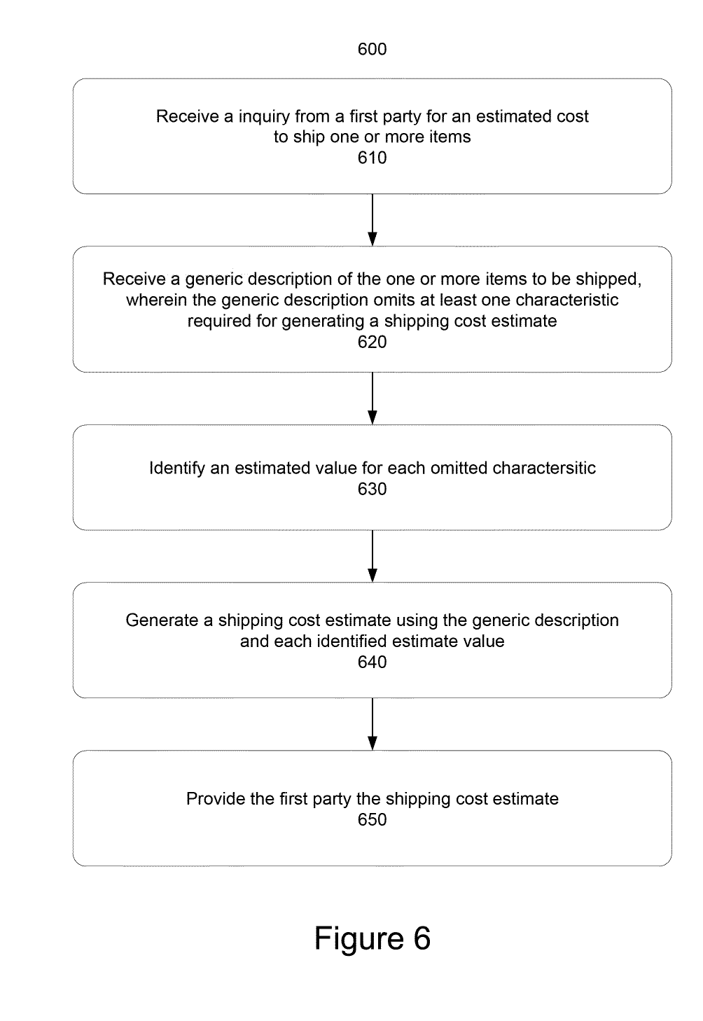

FIG. 6 is a flowchart illustrating a method for providing a shipping cost estimate. In broad overview of the method 600, at step 610, a control server 180 receives an inquiry from a user for an estimated cost to ship one or more items. At step 620, the control server 180 receives a generic description of the one or more items to be shipped; the generic description does not specify every facet or property of the item(s). At step 630, the control server 180 identifies estimated values for the omitted characteristics of the items to be shipped. At step 640, the control server 180 generates a shipping cost estimate using the generic description and each identified estimate value. At step 650, the control server 180 provides the user with the shipping cost estimate and any appropriate options.

At step 610, a control server 180 receives an inquiry from a user for an estimated cost to ship one or more items. The user may interact with an interface 410 provided by the control server 180. The user may be a sender in possession of the item(s), a recipient seeking the item(s), or a third-party coordinator. The user may request an estimate based on a particular destination address. The user may request an estimate based on a destination delivery area, e.g., a zip code, a city, a county, a state, a shipping zone, a country, or any other method of specifying a delivery area. The user may request an estimate that includes a packaging service. For example, the user may wish to ship a table and requests that a carrier collect the table, package the table, and deliver the table.

At step 620, the control server 180 receives a generic description of the one or more items to be shipped. Generally, the generic description does not specify every facet or property of the item(s). That is, the generic description may omit data that carriers require in determining shipping costs. For example, the generic description may fail to include a weight for the items. The generic description may fail to include dimensions. The generic description may include dimensions, but fail to account for additional space required for padding or other packing materials. In some implementations, the control server 180 receives the generic description from a user via an interface 410. In some implementations, the interface 410 prompts the user with suggested high-level descriptions. In some implementations, the interface 410 presents images of generic objects representative of things the user might wish to ship and the user selects from amongst the images. In some implementations, the control server 180 repeats this process for each item to be shipped.

At step 630, the control server 180 identifies estimated values for the omitted characteristics of the items to be shipped. That is, the control server 180 recognizes where the generic description fails to include a facet or aspect required by carriers. In some implementations, the control server 180 uses the method 500 illustrated in FIG. 5 and described above. In some implementations, the control server 180 accesses a database of descriptions, each description paired with estimated characteristics. In some implementations, the control server 180 presents a collection of narrowing descriptions to the user, e.g., via interface 410, where each narrowing description is associated with estimated characteristics for items matching the description, and the user selects a narrowing description. In some implementations, the estimated characteristics are based on known characteristics for common variants matching the descriptions. In some implementations, the estimated characteristics are an average of characteristic values for items matching the descriptions, e.g., items previously shipped through the system.

At step 640, the control server 180 generates a shipping cost estimate using the generic description and each identified estimate value. In some implementations, the shipping cost estimate includes an estimate for a packaging service. In some implementations, the shipping cost estimate accounts for packing material and the likely size of the package, box, or crate to be shipped. For example, the control server 180 may identify that a user wishes to ship a table lamp weighing 6 to 8 pounds, having a base 7 to 10 inches wide and standing 15 to 20 inches tall, with no lamp shade. The control server 180 may recognize that the lamp requires 3 inches of foam padding on each side and that the padding will add half a pound to the overall weight. The resulting shipping cost estimate may be for a box 26 inches tall, 16 inches wide, and weighing up to 8.5 pounds. When the carrier reports the actual size or weight of the package, the control server 180 may update the estimates for the description used.

At step 650, the control server 180 provides the user with the shipping cost estimate and any appropriate options. The control server 180 may provide the estimate via an interface 410. In some implementations, the interface 410 may include an audio or video presentation. For example, the interface 410 may feature an animated avatar that visually and verbally explains the costs and the next steps to the user. The avatar may demonstrate packaging the item to be shipped. In some implementations, as illustrated in FIG. 4, the control server 180 may present multiple carriers and modes of transportation 480. Each combination of carrier and mode of transportation may include an estimated price or price range. Additional services such as pick-up, packaging, insurance, delivery set-up, and tracking may also be indicated in the interface 410. The user may then select the desired options and purchase the shipping services.

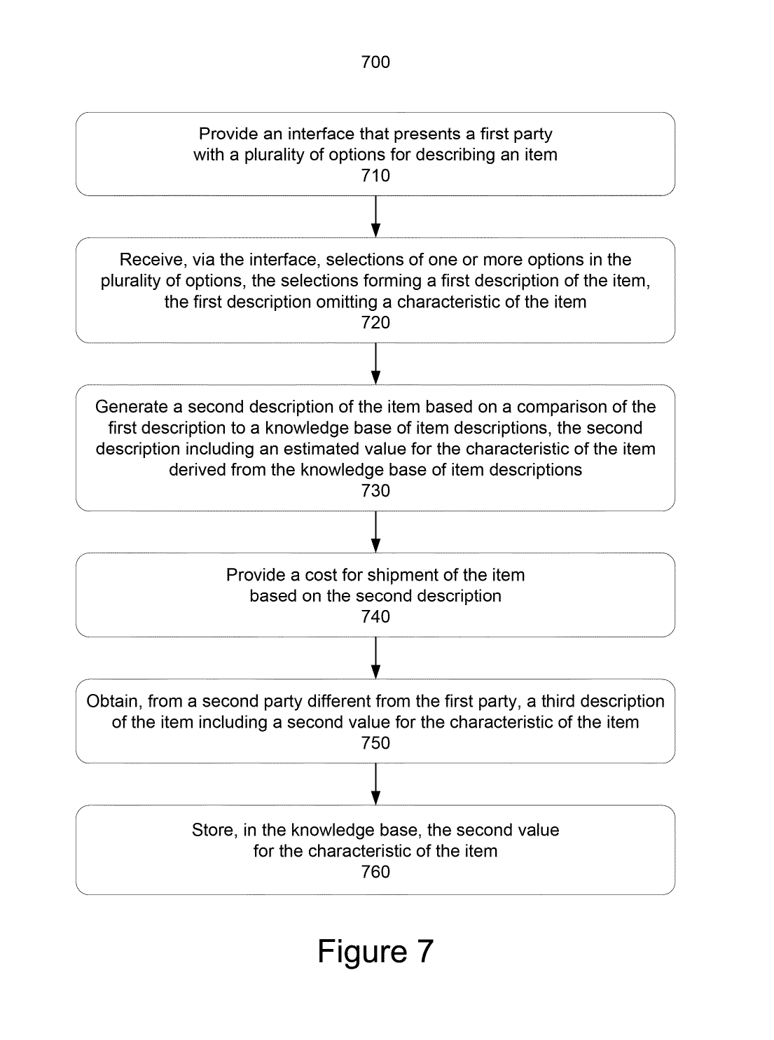

FIG. 7 is a flowchart illustrating a method for improving a knowledge base of item descriptions. In broad overview of the method 700, beginning at step 710, a control server 180 (e.g., via an interface server 182) provides an interface that provides a first party with a plurality of options for describing an item. At step 720, the control server 180 receives, via the interface, selections of one or more options in the plurality of options, the selections forming a first description of the item. At step 730, the control server 180 generates a second description of the item based on a comparison of the first description to a knowledge base of item descriptions (e.g., stored in data storage 184), the second description including an estimated value for a characteristic of the item as derived from the knowledge base. At step 740, the control server 180 provides, via the interface, an estimated cost for shipment of the item based on the second description. At step 750, the control server 180 obtains, from another party (a second party that is different from the first party), a third description of the item including a second value for the characteristic of the item. At step 760, the control server 180 then stores the second value in the knowledge base.

The knowledge base holds the descriptive information in a manner suitable for querying and comparison, e.g., as a relational database. The information is stored, for example, in a data storage 184 (as described in reference to FIG. 1B). In some implementations, the information is stored in one or more tables, e.g., with an entry for each instance, or each unique instance, of an item. Examples of useful data to store in the tables include, but are not limited to: Item name; synonyms for the item name; text description of the item; a general classification (e.g., “Kitchen Furniture” or “Table”); a product code (e.g., a Global Trade Item Numbers (“GTIN”) such as an International Article Number (EAN) or Universal Product Code (“UPC”)); a model number; a serial Number; a National Motor Freight Traffic Association (“NMFTA”) freight classification (“NMFC”) code; a Harmonized Tariff Schedule code; context information (e.g., “audio equipment” or “dining room furniture”; this can be helpful in distinguishing homonyms such as “turntable,” which might refer to audio equipment or to rotating serving pieces also known as a “lazy Susan”); unpacked dimensions; unpacked weight (or mass); packaged dimensions; packaged weight (or mass); insurance value; and/or date information. In some implementations, the dimensions are stored in a normalized manner. For example, height, width, and depth may be stored in sorted order regardless of object orientation. In some implementations, the dimensions are stored as specific dimensions, e.g., a specific height, width, depth. In some implementations, combined dimensions are used, such as base area, volume, or girth. In some implementations, information is stored for items both in an unpacked state and also in a properly packaged state. In some implementations, one or more fields may be left unfilled. For example, some items may be commonly packed with other items and thus frequently not have readily available information for a packaged state.

Referring to FIG. 7 in more detail, the control server 180, at step 710, provides, an interface to a first party, e.g., a user with an item to ship. The interface provides the first party with a plurality of options for describing the item. In some implementations, the interface is a an application programming interface (API). In some implementations, the interface is an interactive interface, e.g., a web page or custom application providing a graphical user interface (GUI). In some implementations, the interface is received by a user device 150, as shown in FIG. 1B, which then displays the interface to the user for interaction. In some implementations, the interface is a custom stand-alone application. In some implementations, the interface is made up of one or more web pages presented in the context of a web browser. FIG. 4 is illustrative of one example interactive interface. The control server 180 provides information to the interface, e.g., via an interface server 182 in communication with the user device 150 over a network, and the user interacts with the information to identify an item to be shipped and to select choices for how the item is to be shipped.

Referring still to FIG. 7, at step 720, the control server 180 receives, via the interface, selections of one or more options in the plurality of options, the selections forming a first description of the item. As described in reference to FIG. 5, the control server 180 receives a first description, e.g., lamp, and provides options for narrowing the description, e.g., table lamp or floor lamp. (See, e.g., steps 510 and 520 in FIG. 5). The control server 180 receives selection of a narrowing option and, as needed, iteratively provides and receives options until the user is unable to further narrow the description. (See, e.g., steps 530 and 540 in FIG. 5). The selected options form, collectively, an initial description of the item.

The initial description is at a level of specificity set by the user. If the user does not provide mass or weight information, e.g., because the user does not know how much an item weighs, the initial description will not include mass or weight information. Likewise, if the user does not provide dimensions for an item, e.g., the height, width, depth, girth, or volume of the item, then the initial description does not include dimension information. The first description of the item is, as a result, likely to be incomplete. In general, in order to price shipping costs, carrier companies typically require weight and dimension information (as well, in some situations, as other information such as whether the item is hazardous or requires special handling). Carriers also generally require a classification code (e.g., NMFC). From the perspective of the carrier, the first description is likely to be an insufficient description of the item.

Referring still to FIG. 7, at step 730, the control server 180 generates a second description of the item based on a comparison of the first description to a knowledge base of item descriptions (e.g., stored in data storage 184), the second description including an estimated value for a characteristic of the item as derived from the knowledge base. For example, as described in reference to step 550 in FIG. 5, the control server 180 identifies estimated values for any information missing from the first description in order to construct a more detailed (second) description. The second description is sufficient to satisfy the requirements of the carrier. In some implementations, the selections from step 720 are keywords that are used by the control server 180 as query terms for searching the knowledge base. In some implementations, when the first description includes a specific product identifier (such as a GTIN or manufacturer's model number), the control server 180 compares the specific product identifier to one or more product catalogs and identifies, from the product catalog, the missing information. For example, if the description includes a UPC for particular electronic device, a catalog of electronic devices may contain a comprehensive description of a product sold using the UPC. The comprehensive description is then used by the control server 180 to generate the second description.

At step 730, the control server 180 uses the selections from step 720 to generate the second description. In some implementations, the selections from step 720 are sufficient to identify a specific make and model of a name brand product. When this occurs, the second description can be particularly precise. For example, if a user identifies an item as an Apple® iPad®, then it is likely to be one a limited number of iPad® models, which weigh between 300 and 700 grams and fit in an 8×10 inch box that is at least half an inch thick (plus space for padding). If the user identifies the specific model of iPad®, then the precise dimensions are known, with or without the original box. However, even when the descriptive selections from step 720 do not specify a specific product, the second description can be reasonably precise when the knowledge base has detailed information for items describable by terms similar to those used for the first description.

At step 740, the control server 180 provides, via the interface, a cost for shipment of the item based on the second description. In some implementations, the cost is generated in the manner described for step 640 of the method 600, described in reference to FIG. 6. The control server 180 uses the second description of the item to determine the cost for shipping the item. In some implementations, the control server 180 uses a knowledge base of shipping rates, e.g., stored in data storage 184 (shown in FIG. 1B). In some implementations, the control server 180 requests quotes from one or more carrier servers 190 and aggregates the results. In some implementations, an estimated cost for shipment of the item, based on the second description, is a guaranteed cost. If the user's description of the item is reasonably accurate, the estimated cost is what the user will be charged regardless of the carrier's actual cost.

Referring still to FIG. 7, at step 750, the control server 180 then obtains, from a second party (e.g., a carrier), a third description of the item. The third description includes a value for the characteristic of the item for which a value was not included in the first description and for which a first value was generated at step 730. This is a second value for the characteristic. The second party, which is not the first party, obtains the item and provides the additional information. For example, the first party might be in possession of the item but unable to weigh the item. The second party takes possession of the item and weighs it. As a second example, the first party might not be in possession of the item. For example, the first party may be a buyer from an online auction and only knows what the seller has posted. The second party picks up the item from the seller and measures the physical characteristics of the item. The second party is then able to provide more information than the first party was able to provide. The second party, e.g., a carrier, generates a third description of the item that includes the second value for the previously omitted characteristic of the item and provides the descriptive information to the control server 180. The control server 180 obtains the third description after the first party has committed to shipping the item. In some implementations, as described in reference to step 640 of the method 600, when the carrier reports the actual size or weight of the package, the control server 180 may update the estimates for the description used.

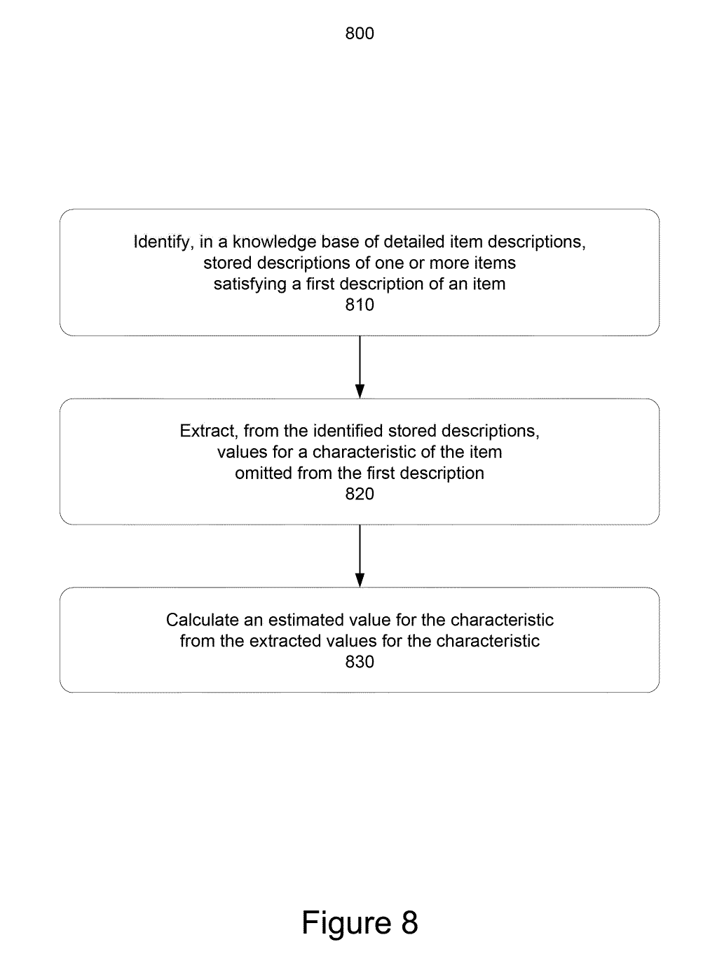

Referring still to FIG. 7, at step 760, the control server 180 then stores the second value in the knowledge base, e.g., in data storage 184. Where the second value is dimension information, e.g., height, width, and depth, there is potential for confusion or mislabeling of a dimension. For example, the orientation of the object may be incorrect. That is, for example, a framed painting may be reported with a height of three feet, a width of four inches, and a depth of two feet; however, it is unlikely that the painting is three feet deep, and more likely that the painting is four inches deep. It is also possible, in some implementations, for the dimensions to be reported without labels, e.g., 36 inches by 4 inches by 24 inches. In some implementations, dimension data is stored in the knowledge base in a normalized order, e.g., sorted. For example, the dimensions for the painting may be stored as (4, 24, 36) inches. The normalized order allows comparison without regard to object orientation. Subsequent searches of the knowledge base for items with similar descriptions can then use the added value to estimate missing descriptive information. The method 800, described in reference to FIG. 8, is one example of using the knowledge base in this manner.

FIG. 8 is a flowchart illustrating a method 800 for calculating an estimated value for a characteristic of an item using a knowledge base of stored descriptions. For example, in some implementations, a control server 180 uses information held in a data store 184 (as shown in FIG. 1B) to estimate values for characteristics not described by an initial item description to generate an improved description of the item. In broad overview, the method 800 begins at step 810 with the control server 180 identifying, in a knowledge base of detailed item descriptions, stored description of one or more items satisfying a first description of an item. At step 820, the control server 180 extracts, from the identified stored descriptions, values for a characteristic of the item omitted from the first description. At step 830, the control server 180 calculates an estimated value for the characteristic from the extracted values for the characteristic.

Referring to FIG. 8 in more detail, at step 810, the control server 180 identifies, in a knowledge base of detailed item descriptions, stored description of one or more items satisfying a first description of an item. For example, a first description may include one or more descriptive terms associated with the item. In some implementations, any stored description including the one or more descriptive terms satisfies the first description. For example, the first description might be “wooden chair,” and the stored descriptions satisfying a query for wood chairs may include “wooden rocking chair,” “wood high chair,” “Windsor chair, wood” and “Thonet 214 Bentwood Chair.” In some implementations, the first description is a natural language description from which key terms are identified and broadened, e.g., converting “wooden” to “wood.” In some implementations, the first description is a set of terms selected from one or more menu of descriptive terms. The menus are constructed to confine term options to relevant unified terms. For example, “wooden” might not be an option, while the more general “wood” may be an option. As a further example, “brick” might be a sub-option for “building materials” but not a sub-option for “chair.” The control server 180 uses the various options to identify, in the knowledge base, one or more detailed item descriptions related to the initial first description of the item. The identified detailed item descriptions each include more information about items similar to item described by the first description. In some implementations, the control server 180 stores the first description in the database as an example description of the item. This example description may contain descriptive elements that, when compared against future requests, can provide elements missing from otherwise similar future requests.

At step 820, the control server 180 extracts, from the identified stored descriptions, values for a characteristic of the item omitted from the first description. The control server 180 determines likely values for the characteristic based on values in the corresponding entries in the knowledge base. For the set of items identified in step 810, there is a set of known values for the characteristic. The control server 180, at step 820, extracts the set of known values corresponding to the missing value in the first description.

In some implementations, the first description obtained received at step 820 may be similar to previously received item descriptions from other shipping requests. The comparison at step 820 can identify similarities between the new description (referred to here as the first description) and the previous, earlier received, descriptions. Earlier descriptions with a large number of descriptive elements overlapping with descriptive elements in the new (first) description can provide some of the missing aspects of the new description. For example, earlier requests to ship a wood chair may include dimensions, but not weight. The new request may include weight, but not dimensions. If the remaining aspects of the descriptions are substantially similar, the dimensions from the earlier requests may be used in estimating dimensions for this new request. In some implementations, a confidence score is generated corresponding to how likely it is that two descriptions are for equivalent items. If the confidence score is above a threshold, then the additional information found in the new description may be used at step 820.

At step 830, the control server 180 calculates an estimated value for the characteristic from the extracted values for the characteristic. The control server 180 uses the set of known values from step 820 to calculate the estimated value. In some implementations, the estimate is an arithmetic mean (average) of the set of known values. In some implementations, the estimate is the median value for the set of known values. In some implementations, the estimate is the maximum value for the set of known values. In some implementations, the estimate is the arithmetic mean (average) for the set of known values, omitting outliers. For example, the bottom 25% and the upper 25% (the Q₁ lower and Q₃ upper quartiles, respectively) may be excluded, and the average is of the middle 50%. In some implementations, the estimated value is the upper quartile threshold value (Q₃) for the set of known values, that is, the value in the set such that 75% of the values in the set are lower than it, and 25% of the values in the set are equal or higher. In some implementation, the estimate is the upper quartile (Q₃) for the set of known values plus a multiple (e.g., 1.5×) of the inter-quartile range (IQR, i.e., the difference between Q₃ and Q₁) for the set of known values. For example, the estimate may be Q₃−1.5×IQR.

For example, if the first description is for a wood chair, but does not include a value for the weight of the chair, the control server 180 calculates an estimated weight for the chair based on the weights for all known wooden chairs. A shipping estimate based on an average weight, or on a upper-quartile weight, may be sufficiently accurate for business purposes.

In some implementations, different methodologies are used for calculating the estimate based on the number of values in the set of known values. That is, in some implementations, if the set is smaller than a threshold value, the maximum value is used, and if the set is larger than the threshold value, then the upper-quartile threshold value Q₃ is used for the estimate. In some such implementations, if the set of values is larger than a second threshold, an arithmetic mean (average) is used for the estimated value.

In some implementations, step 830 calculates characteristics for the item in a packed (or unpacked) state. Data regarding how to pack an item is used to adjust between packed characteristics and unpacked characteristics. If a packed characteristic is omitted, but unpacked characteristics are provided (or vice versa), the packing data is used to determine the omitted characteristic. In some implementations, the control server 180 determines a cost for packing the item, in addition to a cost for shipping the packed item. The cost may include the cost of the packaging materials and/or labor to have an expert pick up an unpacked item and package it correctly. In some implementations, characteristics of the item include how to best package the item.

In some implementations, the price presented is an estimate. The user may be required to authorize a variance from the estimate up to some limit. In some implementations, the control server operator may assume the risk that the estimate is too low and the user may be provided a set price. In some implementations, the price presented may be valid for a fixed period of time. For example, the user may be able to save the price as a quote and purchase the shipping services at a later time.

It should be understood that the systems and methods described above may be provided as instructions in one or more computer programs recorded on or in one or more articles of manufacture, e.g., computer-readable media. The article of manufacture may be a floppy disk, a hard disk, a CD-ROM, a flash memory card, a PROM, a RAM, a ROM, or a magnetic tape. In general, the computer programs may be implemented in any programming language, such as LISP, Perl, C, C++, C#, PROLOG, or in any byte code language such as JAVA. The software programs may be stored on or in one or more articles of manufacture as object code.

Having described certain implementations and embodiments of methods and systems, it will now become apparent to one of skill in the art that other implementations incorporating the concepts of the disclosure may be used. Therefore, the disclosure should not be limited to certain implementations or embodiments, but rather should be limited only by the spirit and scope of the following claims.

What is claimed is:

1. A method of estimating descriptive information for an object, the method comprising:
providing an interface to a first party, the interface providing the first party with a plurality of options for describing an item;
receiving, via the interface, selections of one or more options in the plurality of options, the selections forming a first description of the item, the first description omitting a characteristic of the item;
generating a second description of the item based on a comparison of the first description to a knowledge base of item descriptions, the second description including an estimated value for the characteristic of the item derived from the knowledge base of item descriptions;
providing a cost for shipment of the item based on the second description;
obtaining, from a second party different from the first party, a third description of the item including a second value for the characteristic of the item; and
storing, in the knowledge base, the second value for the characteristic of the item.

2. The method of claim 1, comprising storing, in the knowledge base, the first description of the item.

3. The method of claim 1, wherein the second party is one of: a courier, a transport company, a shipping services provider, or a common carrier.

4. The method of claim 1, wherein the characteristic of the item is one of a mass, weight, height, width, depth, girth, or volume of the item.

5. The method of claim 1, comprising
identifying, in the knowledge base of detailed item descriptions, stored descriptions of one or more items satisfying the first description;
extracting, from the identified stored descriptions, values for the characteristic; and
calculating the estimated value for the characteristic from the extracted values for the characteristic.

6. The method of claim 5, wherein calculating the estimated value for the characteristic from the extracted values for the characteristic comprises calculating an average of the extracted values for the characteristic.

7. The method of claim 5, wherein the first description is a set of selected options for describing the item and wherein identifying, in the knowledge base of detailed item descriptions, stored descriptions of one or more items satisfying the first description comprises identifying stored descriptions that include the set of selected options.

8. The method of claim 5, wherein the first description is a set of selected options for describing the item and wherein identifying, in the knowledge base of detailed item descriptions, stored descriptions of one or more items satisfying the first description comprises identifying stored descriptions that include at least a sub-set of selected options.

9. The method of claim 1, comprising:
receiving, from the second party, a description of a container holding the first item;
estimating a maximum value for the characteristic of the first item based on the description of the container; and
using the estimated maximum value as the second value for the characteristic of the item.

10. The method of claim 1, comprising coordinating, based on the second description, shipment of the item by the second party.

11. A system for estimating descriptive information for an object, the system comprising:
a knowledge base of item descriptions;
a computing processor;
memory storing instructions that, when executed by the computing processor, cause the computing processor to:
provide an interface to a first party, the interface providing the first party with a plurality of options for describing an item;
receive, via the interface, selections of one or more options in the plurality of options, the selections forming a first description of the item, the first description omitting a characteristic of the item;
generate a second description of the item based on a comparison of the first description to the knowledge base of item descriptions, the second description including an estimated value for the characteristic of the item derived from the knowledge base of item descriptions;
provide a cost for shipment of the item based on the second description;
obtain, from a second party different from the first party, a third description of the item including a second value for the characteristic of the item; and
store, in the knowledge base, the second value for the characteristic of the item.

12. The system of claim 11, the memory further storing instructions that, when executed by the computing processor, cause the computing processor to store, in the knowledge base, the first description of the item.

13. The system of claim 11, wherein the characteristic of the item is one of a mass, weight, height, width, depth, girth, or volume of the item.

14. The system of claim 11, the memory further storing instructions that, when executed by the computing processor, cause the computing processor to:
identify, in the knowledge base of detailed item descriptions, stored descriptions of one or more items satisfying the first description;
extract, from the identified stored descriptions, values for the characteristic; and
calculate the estimated value for the characteristic from the extracted values for the characteristic.

15. The system of claim 14, the memory further storing instructions that, when executed by the computing processor, cause the computing processor to calculate the estimated value for the characteristic from the extracted values for the characteristic by calculating an average of the extracted values for the characteristic.

16. The system of claim 14, wherein the first description is a set of selected options for describing the item and wherein the memory further stores instructions that, when executed by the computing processor, cause the computing processor to identify, in the knowledge base of detailed item descriptions, stored descriptions of one or more items satisfying the first description by identifying stored descriptions that include the set of selected options.

17. The system of claim 14, wherein the first description is a set of selected options for describing the item and wherein the memory further stores instructions that, when executed by the computing processor, cause the computing processor to identify, in the knowledge base of detailed item descriptions, stored descriptions of one or more items satisfying the first description by identifying stored descriptions that include at least a sub-set of selected options.

18. The system of claim 11, the memory further storing instructions that, when executed by the computing processor, cause the computing processor to:
receive, from the second party, a description of a container holding the first item;
estimate a maximum value for the characteristic of the first item based on the description of the container; and
use the estimated maximum value as the second value for the characteristic of the item.

19. A non-transitory computer readable media storing instructions that, when executed by a computing processor, cause the computing processor to:
provide an interface to a first party, the interface providing the first party with a plurality of options for describing an item;
receive, via the interface, selections of one or more options in the plurality of options, the selections forming a first description of the item, the first description omitting a characteristic of the item;
generate a second description of the item based on a comparison of the first description to a knowledge base of item descriptions, the second description including an estimated value for the characteristic of the item derived from the knowledge base of item descriptions;
provide a cost for shipment of the item based on the second description;
obtain, from a second party different from the first party, a third description of the item including a second value for the characteristic of the item; and
store, in the knowledge base, the second value for the characteristic of the item.

20. The computer readable media of claim 19, computer readable media storing instructions that, when executed by the computing processor, cause the computing processor to:
identify, in the knowledge base of detailed item descriptions, stored descriptions of one or more items satisfying the first description;
extract, from the identified stored descriptions, values for the characteristic; and
calculate the estimated value for the characteristic from the extracted values for the characteristic.
